(19) United States
(12) Patent Application Publication
(10) Pub. No.: US 2013/0154904 A1
(43) Pub. Date: Jun. 20, 2013

(54) AUTOMATIC DEVICE CONTROL APPARATUS FOR AUTOMATICALLY CONTROL DEVICE AND APPLICATION OF INFORMATION PROCESSING APPARATUS SUCH AS COMPUTER

(71) Applicant: PANASONIC CORPORATION, Osaka (JP)

(72) Inventor: Koji SASAKI, Osaka (JP)

(73) Assignee: PANASONIC CORPORATION, Osaka (JP)

(21) Appl. No.: 13/719,394

(22) Filed: Dec. 19, 2012

(30) Foreign Application Priority Data
Dec. 20, 2011 (JP) 2011-278113
Dec. 12, 2012 (JP) 2012-271654

(51) Int. Cl. G09G 3/00

(52) U.S. Cl. CPC G09G 3/00
USPC 345/1.1

(57) ABSTRACT

An automatic device control apparatus is provided for displaying display data on a display terminal apparatus. A device detecting section detects a corresponding device by detecting one of an event that an external storage device that stores the display data is connected to the information processing apparatus and an event that application software to display the display data is activated, and a device information acquiring section acquires information of a detected device. A communication device setting section extracts a communication device communicable with the display terminal apparatus, and generates information of the communication device, and a schedule managing section judges whether or not the detected device and the communication device are activated, and forms an execution processing schedule. A display terminal retrieving section retrieves the display terminal apparatus to be transmitted, and a display terminal connecting section performs connecting with the retrieved display terminal apparatus, and transmits the display data.

### BACKGROUND OF THE DISCLOSURE

1. Field of the Disclosure

This disclosure of the present disclosure relates to an automatic device control apparatus, method, and an information processing apparatus. This disclosure relates, for example, to an automatic device control apparatus and method for automatically executing control of related devices or predetermined applications according to a predefined schedule by monitoring devices on a computer when a registered device is newly recognized, and an information processing apparatus such as a computer having the automatic device control apparatus. This makes it possible to simply specify an objective terminal and to transmit data.

2. Description of the Related Art

Conventionally, when data is transmitted to a display terminal apparatus that displays objective data, it is necessary to specify the objective display terminal, insert a recording device that stores the display data to be transmitted into an information processing apparatus such as a personal computer, and connect the device to a network where the objective display terminal exists. For the above purpose, an application program for transmitting the data is first activated, and advance preparations for transmitting the display data are performed. This is subsequently followed by executing a predetermined data transmitting process, inserting the recording device directly into the objective display terminal apparatus, displaying the transmission data directly on the objective display terminal apparatus, and so on (See, for example, a Patent Document 1 of Japanese patent laid-open publication No. JP 2007-212619 A).

The Patent Document 1 discloses a projection type image display apparatus that automatically detects the input of the device by a device detector circuit owned by a display device such as a projector, and automatically displays the data on a screen or the like.

However, in the conventional automatic device control apparatus, predetermined advance preparations are needed when the display data stored in an external storage device (for example, USB (registered trademark) memory or SD (registered trademark) memory) is transmitted to the display terminal apparatus. For example, as the predetermined advance preparations, the operations of activating a predetermined application, specifying the objective display terminal apparatus of transmission, and selecting the transmission data are needed each time. Moreover, it is necessary to specify the information of the network to be used, the information of the LAN (Local Area Network) device, and the like upon performing various settings, and this leads to such a problem that the user is required to have preliminary knowledges.

### SUMMARY OF THE DISCLOSURE

The present disclosure is to provide an automatic device control apparatus and method capable of automatically performing a series of operations of automatically detecting the objective storage device and communication device, executing predetermined control, and transmitting display data to the display terminal apparatus when such an event that an external storage device (such as USB memory or CD-R) that stores the desired display data has been connected is detected, and an information processing apparatus having the automatic device control apparatus.

According to one aspect of the disclosure, there is provided an automatic device control apparatus configured to display display data on a display terminal apparatus connected to an information processing apparatus, and the automatic device control apparatus includes a device detecting section, a device information acquiring section, a communication device setting section, a schedule managing section, a display terminal retrieving section, and a display terminal connecting section. The device detecting section is configured to detect a corresponding device by detecting one of such an event that an external storage device that stores the display data is connected to the information processing apparatus and such an event that application software to display the display data is activated. The device information acquiring section is configured to acquire information of a detected device based on a detection result of the device detected by the device detecting section. The communication device setting section is configured to extract a communication device communicable with the display terminal apparatus, and generate and setting information of the communication device. The schedule managing section is configured to execute an activation judgment process for judging whether or not the detected device and the communication device are activated based on the information of the detected device and the information of the communication device, and form a predetermined execution processing schedule from the information of the activated detected device and the communication device when it is judged that the detected device and the communication device are activated. The display terminal retrieving section is configured to automatically retrieve the display terminal apparatus to which the display data is transmitted according to the execution processing schedule. The display terminal connecting section is configured to perform connecting with the retrieved display terminal apparatus, and transmit the display data to the display terminal apparatus.

The automatic device control apparatus of the present disclosure automatically specifies a preset LAN device (communication device) or a usable LAN device, automatically executes control according to a predetermined execution processing schedule, and automatically performs connection to the objective display terminal apparatus merely by inserting the external storage device or the like that stores display data contents into the automatic device control apparatus. Therefore, it is possible to simply transmit the desired display data to the display terminal apparatus without performing predetermined advance preparations accompanied by complex operations.

Moreover, it is also possible to simply transmit the desired display data to the display terminal apparatus by detecting not only the external storage device but also the event that a specified application is activated.

### BRIEF DESCRIPTION OF THE DRAWINGS

These and other objects and features of the present disclosure will become clear from the following description taken in conjunction with the embodiments thereof with reference to the accompanying drawings throughout which like parts are designated by like reference numerals, and in which:

FIG. 1 is a block diagram showing a configuration of an automatic device control apparatus 100 according to the first embodiment of the present disclosure;

FIG. 2 is a block diagram showing a configuration of a device detector circuit 101 of FIG. 1;

FIG. 3 is a block diagram showing a configuration of a device information acquiring circuit 102 of FIG. 1;

FIG. 4 is a block diagram showing a configuration of a registration LAN device setting circuit 104 of FIG. 1;

FIG. 5 is a block diagram showing a configuration of a registration LAN device storage circuit 105 of FIG. 1;

FIG. 6 is a block diagram showing a configuration of a schedule manager circuit 103 of FIG. 1;

FIG. 7 is a block diagram showing a configuration of a display terminal retrieving circuit 106 of FIG. 1;

FIG. 8 is a block diagram showing a configuration of a display terminal connecting circuit 107 of FIG. 1;

FIG. 9 shows tables for explaining a device detection process of the automatic device control apparatus 100 of FIG. 1, where FIG. 9(a) shows device detailed information 89-1 and LAN device detailed information 89-2, FIG. 9(b1) shows a storage device table T1, FIG. 9(b2) shows a registered LAN device table T2, and FIG. 9(c) shows activated device detailed information 90;

FIG. 10 shows tables for explaining an execution processing schedule forming operation of the automatic device control apparatus 100 of FIG. 1, where FIG. 10(a) shows registration and execution processing schedule 91, FIG. 10(b) shows registered data 92, and FIG. 10(c) shows a formed execution processing schedule 93;

FIG. 11 is a block diagram showing a personal computer 10 having an display data automatic transmission process program 100P related to the second embodiment of the present disclosure;

FIG. 12 is a flow chart showing a display data automatic transmission process in the display data automatic transmission process program 100P of FIG. 11;

FIG. 13 is a flow chart showing an activation judging process of a LAN device and an external storage device, serving as a subroutine of FIG. 12;

FIG. 14 is a diagram for explaining one example of transmitting the display data when an external storage device 60 is inserted into the personal computer 10 of FIG. 11; and

FIG. 15 is a diagram for explaining one example of transmitting the display data when application software is activated in the personal computer 10 of FIG. 11.

### DETAILED DESCRIPTION OF THE EMBODIMENTS

Embodiments will be described below with reference to the drawings. Note that in the following embodiments like components are denoted by the same reference characters.

Embodiments will be described in detail below arbitrarily with reference to the drawings. It is sometimes a case where a detailed description more than necessary is omitted. For example, it is sometimes a case where a detailed description of already well-known matters and a repetitive explanation of a substantially identical configuration are omitted. This is to avoid unnecessary redundancy of the following description and facilitate easy understanding by those skilled in the art. The inventor provides the accompanying drawings and the following description for sufficient understanding by those skilled in the art, and does not intend to limit the subjects described in the claims by them.

### First Embodiment

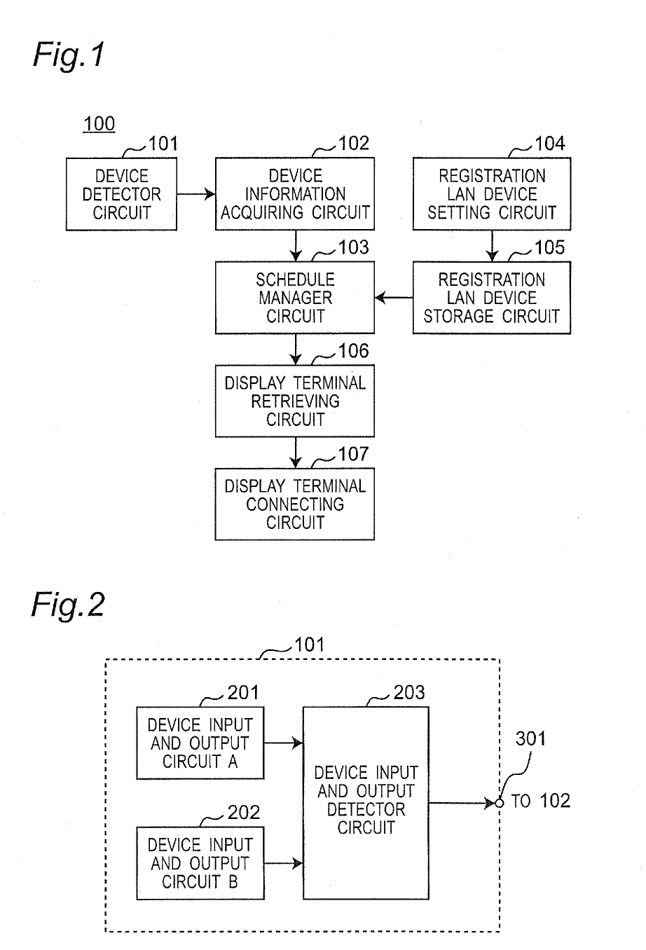

FIG. 1 is a block diagram showing a configuration of an automatic device control apparatus 100 according to the first embodiment of the present disclosure. Referring to FIG. 1, the automatic device control apparatus 100 of the first embodiment is configured to include a device detector circuit 101, a device information acquiring circuit 102, a schedule manager circuit 103, a registration LAN device setting circuit 104, a registration LAN device storage circuit 105, a display terminal retrieving circuit 106, and a display terminal connecting circuit 107. The automatic device control apparatus 100 of the first embodiment may be mounted on, for example, an information processing apparatus such as a personal computer. Details are described later.

The device detector circuit 101 detects whether an external storage device (for example, USB memory, SD memory or CD-R) that stores the display data concerning a variety of contents data has been connected to the information processing apparatus on which the self-apparatus 100 is mounted. A result detected by the device detector circuit 101 is inputted to the device information acquiring circuit 102. The device information acquiring circuit 102 acquires detailed information (for example, information of the type (or kind), configuration, and contents) of the detected external storage device based on the detection result of the inputted external storage device, and outputs the acquired detailed information of the external storage device to the schedule manager circuit 103.

The registration LAN device setting circuit 104 manages the whole of the information of the LAN devices mounted on the information processing apparatus on which the automatic device control apparatus 100 is mounted, and extracts effectively communicable LAN devices. Then, the registration LAN device setting circuit 104 forms and sets a prioritized LAN device list from the extracted LAN devices, and outputs the formed LAN device list to the registration LAN device storage circuit 105. The registration LAN device storage circuit 105 stores the LAN device list inputted from the registration LAN device setting circuit 104 or a preparatorily stored LAN device list. More concretely, the registration LAN device storage circuit 105 stores detailed information of the LAN devices preferentially selected from the LAN device list or the detailed information (for example, IP address, and connection destination information) of the LAN devices for preferentially using the stored LAN device list when a LAN device that coincides with the preparatorily stored LAN device list exists. The stored LAN device detailed information is read to the schedule manager circuit 103.

The schedule manager circuit 103 judges whether or not the LAN device and the external storage device are activated based on the external storage device detailed information inputted from the device information acquiring circuit 102 and the LAN device detailed information inputted from the registration LAN device storage circuit 105, and forms a predetermined execution processing schedule that describes a processing procedure according to the type of the device detailed information when they are activated. The schedule manager circuit 103 outputs the formed execution processing schedule to the display terminal retrieving circuit 106.

The display terminal retrieving circuit 106 executes a predetermined control process for the related external storage device and the objective LAN device to be controlled according to the inputted execution processing schedule, and executes an advance preparation process for retrieving the objective display terminal apparatus to which the display data is transmitted. When the whole control process is completed, the display terminal retrieving circuit 106 acquires retrieval information (for example, list of transmittable display terminal apparatuses), and outputs the retrieval information to the display terminal connecting circuit 107. The display terminal connecting circuit 107 executes a predetermined connecting process for the objective display terminal apparatus based on the inputted retrieval information, and completes the connecting process. When the connecting process is completed, the display terminal connecting circuit 107 transmits the preparatorily acquired detailed information of the external storage device and the display data to the display terminal apparatus of which the connecting process has been completed.

FIG. 2 is a block diagram showing a configuration of the device detector circuit 101 of FIG. 1. Referring to FIG. 1, the device detector circuit 101 is configured to include a device input and output circuit A201, a device input and output circuit 13202, and a device input and output detector circuit A203.

Referring to FIG. 2, the device input and output circuit A201 and the device input and output circuit B202 notify the device input and output detector circuit 203 of the input and output information of the external storage device (for example, USB memory) that stores contents information of the display data. For example, when the external storage device is inserted, the device input and output circuit A201 and the device input and output circuit B202 notify the device input and output detector circuit 203 of the input information of the external storage device. When an external storage device is deleted, the device input and output circuit A201 and the device input and output circuit B202 notify the device input and output detector circuit 203 of the deletion information of the external storage device. The device input and output detector circuit 203 detects the external storage device that has been newly inserted or deleted from the inputted input and output information, and, when the inserted external storage device is detected from the input information of the external storage device, outputs the detection result of the detected external storage device to the device information acquiring circuit 102 via a terminal 301.

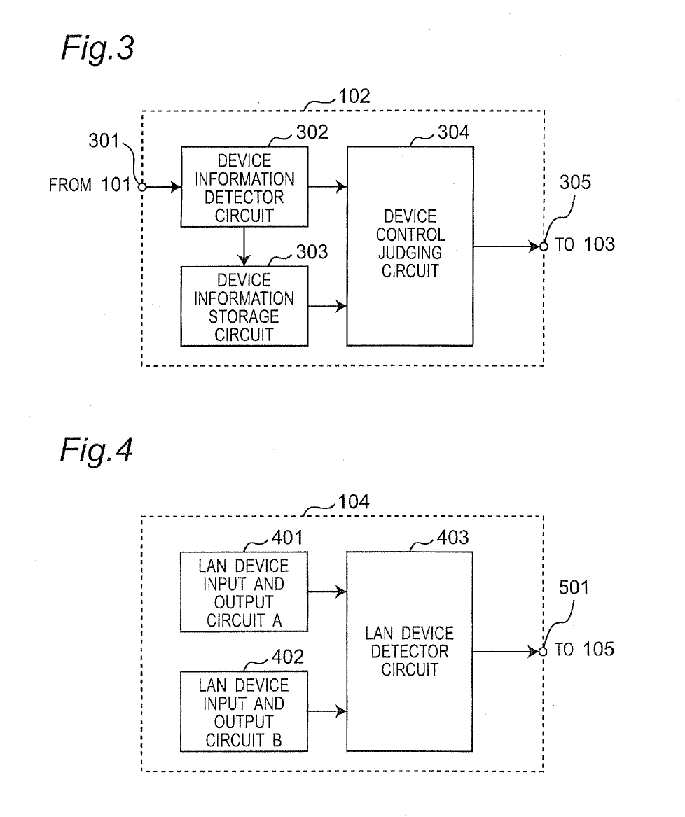

FIG. 3 is a block diagram showing a configuration of the device information acquiring circuit 102 of FIG. 1. As shown in FIG. 3, the device information acquiring circuit 102 is configured to include a device information detector circuit 302, a device information storage circuit 303, and a device control judging circuit 304.

Referring to FIG. 3, the external storage device detection result inputted from the terminal 301 is inputted to the device information detector circuit 302. Upon receiving the detection result of the detected external storage device, the device information detector circuit 302 acquires the equipment information (for example, model, device type, and stored data information) of the external storage device set as the external storage device. The device information detector circuit 302 outputs the acquired equipment information of the external storage device to the device information storage circuit 303 and the device control judging circuit 304. The device information storage circuit 303 stores the equipment information (for example, model, device type, and stored data information) of the preparatorily stored storage device. Then, the device information storage circuit 303 compares the equipment information of the inputted external storage device with the equipment information of the stored storage device, and outputs a comparison result as to whether or not the equipment information of the inputted external storage device and the equipment information of the stored storage device coincide with each other to the device control judging circuit 304. When the comparison result inputted from the device information storage circuit 303 indicates the purport of coincidence, the device control judging circuit 304 judges that it is the objective external storage device to be controlled. Then, the device control judging circuit 304 outputs the device equipment information of the external storage inputted from the device information detector circuit 302 as the equipment information of the inserted external storage device as it is to the schedule manager circuit 103 via a terminal 305.

FIG. 4 is a block diagram showing a configuration of the registration LAN device setting circuit 104 of FIG. 1. As shown in FIG. 4, the registration LAN device setting circuit 104 is configured to include a LAN device input and output circuit A 401, a LAN device input and output circuit B 402, and a LAN device detector circuit 403.

Referring to FIG. 4, the LAN device input and output circuit A 401 and the LAN device input and output circuit B 402 notify the LAN device detector circuit 403 of the input and output information of the LAN device (for example, communication devices such as a wired LAN device and a wireless LAN device) communicable with the personal computer on which the automatic device control apparatus 100 is mounted. In this case, the input and output information of the LAN device is information that includes the activated state/invalid state and connection/unconnection of the communication device. Details are described later. The LAN device detector circuit 403 detects the communicable LAN device based on the inputted input and output information of the LAN device. The LAN device detector circuit 403 forms a detection list of the detected LAN devices, and outputs the detected list to the registration LAN device storage circuit 105 via a terminal 501.

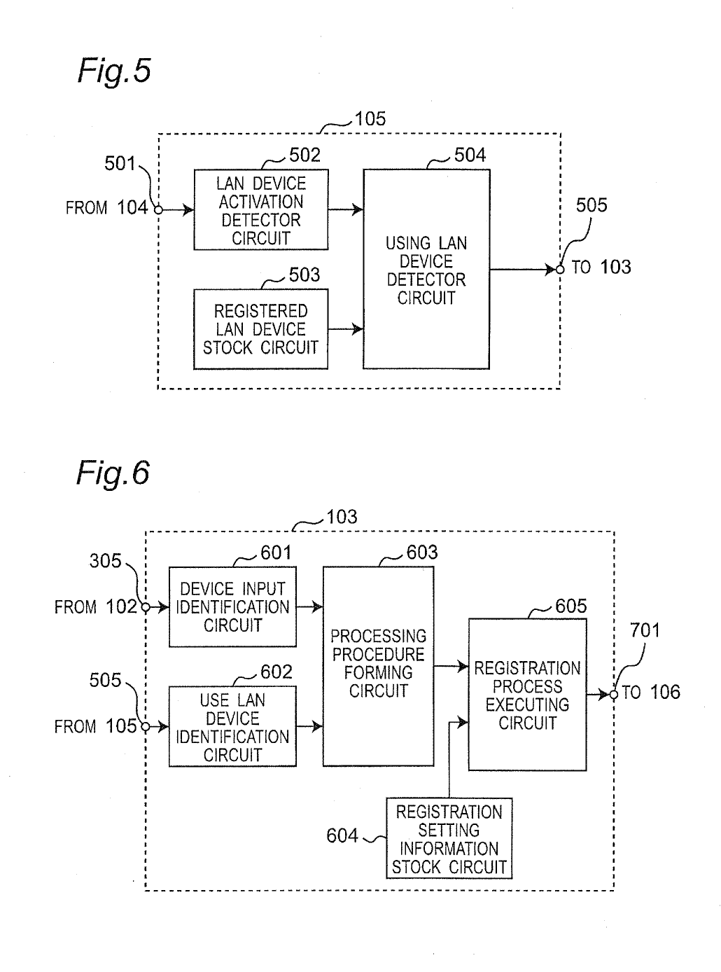

FIG. 5 is a block diagram showing a configuration of the registration LAN device storage circuit 105 of FIG. 1. As shown in FIG. 5, the registration LAN device storage circuit 105 is configured to include a LAN device activation detector circuit 502, a registered LAN device stock circuit 503, and a using LAN device detector circuit 504.

Referring to FIG. 5, the LAN device activation detector circuit 502 lists up again the usable LAN devices based on the LAN device detection list inputted from the terminal 501, forms an activated LAN device usable list, and outputs the list to the using LAN device detector circuit 504. The registered LAN device stock circuit 503 preparatorily stores the registration information of the selection criteria of the registration information of the LAN device desired to be used or the LAN device to be preferentially used. The registered LAN device stock circuit 503 outputs the stored registration information of the LAN devices to using LAN device detector circuit 504. The using LAN device detector circuit 504 detects the LAN device to be controlled from the usable LAN device information based on the usable LAN device list formed in the LAN device activation detector circuit 502 and the LAN device registration information inputted from the registered LAN device stock circuit 503. The using LAN device detector circuit 504 outputs the detected information of the LAN device to be controlled to the schedule manager circuit 103 via a terminal 505.

FIG. 6 is a block diagram showing a configuration of the schedule manager circuit 103 of FIG. 1. The schedule manager circuit 103 is configured to include a device input identification circuit 601, a using LAN device identification circuit 602, a processing procedure forming circuit 603, a registration setting information stock circuit 604, and a registration process executing circuit 605.

Referring to FIG. 6, the device input identification circuit 601 specifies the inputted external storage device type (for example, USB memory or CD-R) from the external storage device detailed information inputted from the device information acquiring circuit 102 via the terminal 305. The device input identification circuit 601 acquires data to be used for data transmission from the specified external storage device type information, and outputs the acquired storage device identification information to the processing procedure forming circuit 603. The using LAN device identification circuit 602 acquires the using LAN device identification information from the LAN device detailed information inputted from the registration LAN device storage circuit 105 via the terminal 505, and outputs the acquired LAN device identification information to the processing procedure forming circuit 603. The processing procedure forming circuit 603 forms a control process procedure based on the inputted storage device identification information acquired by the device input identification circuit 601 and the inputted LAN device identification information device acquired by the using LAN device identification circuit 602, and outputs this to the registration process executing circuit 605. The registration setting information stock circuit 604 preparatorily stores various setting information (for example, network connection information, registered IP information, and transmission data type information) desired to be used. The registration setting information stock circuit 604 outputs the stored setting storage information to the registration process executing circuit 605. The registration process executing circuit 605 forms an execution processing schedule concerning the detailed setting information for controlling the LAN device according to the prepared processing procedure for the LAN device to be used based on the control process procedure formed in the processing procedure forming circuit 603 and the setting storage information read from the registration setting information stock circuit 604. The registration process executing circuit 605 outputs the formed execution processing schedule as schedule data to the display terminal retrieving circuit 106 via a terminal 701.

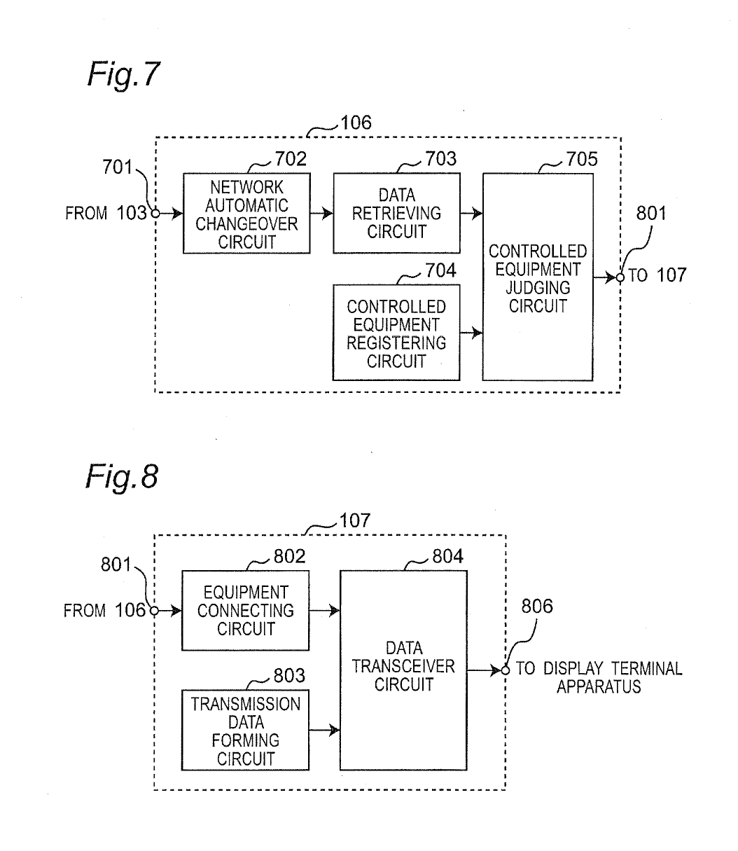

FIG. 7 is a block diagram showing a configuration of the display terminal retrieving circuit 106 of FIG. 1. As shown in FIG. 7, the display terminal retrieving circuit 106 is configured to include a network automatic changeover circuit 702, a data retrieving circuit 703, an controlled equipment registering circuit 704, and a controlled equipment judging circuit 705.

Referring to FIG. 7, the network automatic changeover circuit 702 automatically performs changeover of the network to be connected by controlling the LAN device to be used according to the schedule data inputted via the terminal 701. At the time point when the changeover of the network is completed, the network automatic changeover circuit 702 outputs a changeover completion notification to the data retrieving circuit 703. Upon detecting that the changeover to the connection network by the changeover completion notification, the data retrieving circuit 703 executes a predetermined data retrieving process, and outputs a retrieving process execution completion notification to the controlled equipment judging circuit 705. The controlled equipment registering circuit 704 stores the controlled equipment information to be controlled when the objective equipment to be controlled has been preparatorily determined or stores equipment condition information for using the equipment conforming to the conditions by preparing a plurality of conditions of the objective equipment to be controlled when the objective equipment to be controlled is not determined. The controlled equipment registering circuit 704 outputs the stored controlled equipment registration information to the controlled equipment judging circuit 705. The controlled equipment judging circuit 705 detects the retrieving process execution completion notification inputted from the data retrieving circuit 703, and thereafter, specifies the controlled equipment to be used based on the controlled equipment information responded from the network and the controlled equipment registration information stored in the controlled equipment registering circuit 704. The controlled equipment judging circuit 705 outputs the specified result to the display terminal connecting circuit 107 via a terminal 801.

FIG. 8 is a block diagram showing a configuration of the display terminal connecting circuit 107 of FIG. 1. The display terminal connecting circuit 107 is configured to include an equipment connecting circuit 802, a transmission data forming circuit 803, and a data transceiver circuit 804.

Referring to FIG. 8, the equipment connecting circuit 802 makes a connection to a display terminal apparatus in order to enable the detected controlled equipment to be used inputted via the terminal 801 to transmit and receive the objective display data. The equipment connecting circuit 802 outputs a completion notification of the connection of the equipment to be controlled for notification of the connection completion to the data transceiver circuit 804. The transmission data forming circuit 803 performs a predetermined communication data generating process for the display data to be transmitted to the display terminal apparatus, and forms transmission data. The transmission data forming circuit 803 outputs the formed transmission data to the data transceiver circuit 804. The data transceiver circuit 804 detects the connection completion notification outputted from the equipment connecting circuit 802, and thereafter, transmits the transmission data formed in the transmission data forming circuit 803 to the display terminal apparatus that becomes the object to be controlled.

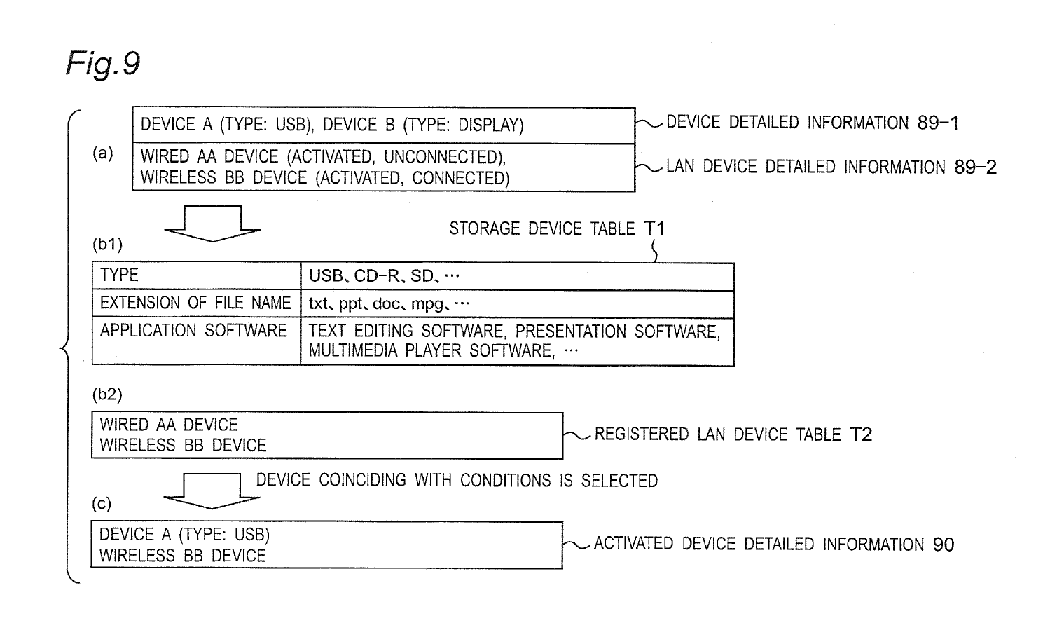

FIG. 9 shows tables for explaining the device detection process of the automatic device control apparatus 100 of FIG. 1. FIG. 9(a) shows detailed information 89-1 of the device detected by the device information acquiring circuit 102 and detailed information 89-2 of the LAN device detected by the registration LAN device storage circuit 105. In this case, referring to FIG. 9(a), an example in which a device A (USB memory regarding the type) and a device B (display regarding the type) are detected as the device detailed information 89-1 is shown. Moreover, referring to FIG. 9(a), an example in which a wired AA device (activated, in an unconnected state) and a wireless BB device (activated, in a state connected to an arbitrary network) are detected as the LAN device detailed information 89-2 is shown.

FIG. 9(b1) shows a storage device table T1 to which the schedule manager circuit 103 refers. Although the example in which the schedule manager circuit 103 preparatorily refers to the storage device table T1 is shown in the first embodiment, the disclosure is not limited to this. Referring to FIG. 9(b1), the types of storage devices, the extensions of the file name of contents and applications are registered in the storage device table T1. The types of the registered storage devices include USB, CD-R, SD, and so on. The extensions of the file name of the registered objective contents include txt, ppt, doc, mpg, and so on. The registered applications include text editing software, presentation software, multimedia player software, and so on.

FIG. 9(b2) shows a registered LAN device table T2 to which the schedule manager circuit 103 refers. Although the example in which the schedule manager circuit 103 preparatorily refers to the registered LAN device table T2 is shown in the first embodiment, the disclosure is not limited to this. Referring to FIG. 9(b2), the wired AA device and the wireless BB device are registered as LAN devices to be used in the registered LAN device table T2, and the purport that, when the wired AA device and the wireless BB device are activated and in a usable state, the device is preferentially used is registered.

FIG. 9(c) shows detailed information 90 of the activated device. Referring to FIG. 9(c), the schedule manager circuit 103 judges whether or not the acquired detailed information of the storage device coincides with the device information in the storage device table T1 with reference to the storage device table T1. In this case, the device A (USB memory regarding the type) of the device A (USB memory regarding the type) and the device B (display regarding the type) of the acquired detailed information of the external storage devices shown in FIG. 9(a) coincides with USB among the types in the storage device table T1. Therefore, the schedule manager circuit 103 selects the device A (USB memory regarding the type) as the objective storage device to be controlled.

Likewise, the schedule manager circuit 103 judges whether or not the acquired detailed information of the LAN device coincides with the device information in the registered LAN device table T2 with reference to the registered LAN device table T2. In this case, the wireless BB device of the wired AA device (activated, in an unconnected state) and the wireless BB device (activated, in a state connected to an arbitrary network) of the acquired detailed information of the LAN devices shown in FIG. 9(a) is activated and in the state connected to the arbitrary network. Therefore, the schedule manager circuit 103 preferentially selects the wireless BB device than the wired AA device as the objective LAN device to be controlled.

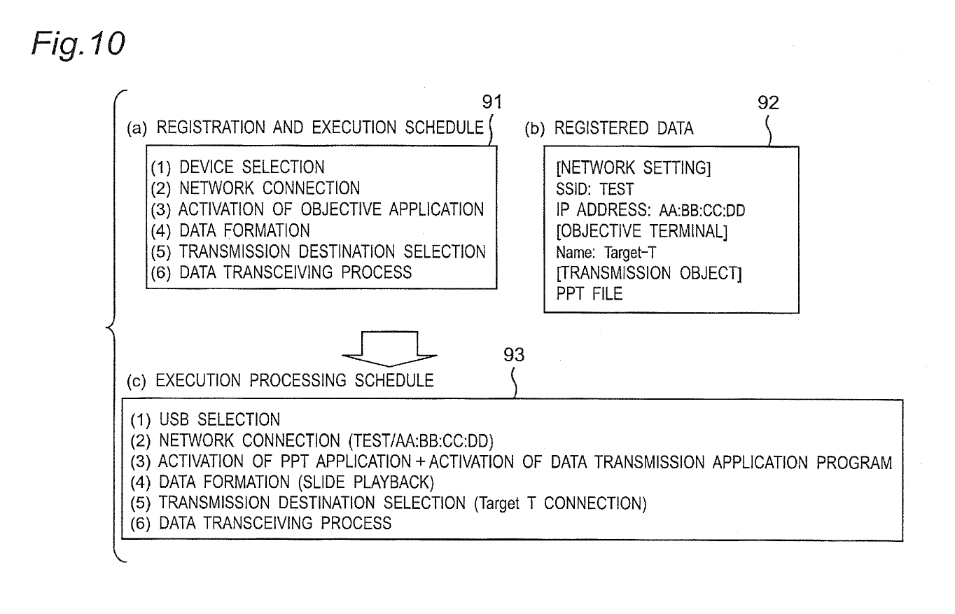

FIG. 10 shows tables for explaining the execution processing schedule forming operation of the automatic device control apparatus 100 of FIG. 1. FIG. 10(a) shows a registration and execution processing schedule 91 preparatorily registered in the schedule manager circuit 103. FIG. 10(b) shows a registered data 92 preparatorily stored by the registration LAN device storage circuit 105. FIG. 10(c) shows an execution processing schedule 93 formed by the schedule manager circuit 103.

In this case, referring to FIG. 10(a), the registration and execution processing schedule 91 preparatorily stores the following:

(1) device selection;

(2) network connection;

(3) activation of objective application;

(4) data formation;

(5) transmission destination selection; and

(6) predetermined schedule of data transceiving process.

The schedule manager circuit 103 forms the concrete execution processing schedule shown in FIG. 10(c) by applying the registered data 92 shown in FIG. 10(b) and the detailed information 90 of the activated devices shown in FIG. 9(c) to the registration and execution processing schedule 91 shown in FIG. 10(a).

Referring to FIG. 10(c), the schedule manager circuit 103 selects, for example, the USB memory device of the devices selected in FIG. 9(c) regarding the (1) device selection. The schedule manager circuit 103 selects the wireless BB device selected in FIG. 9(c) regarding the (2) network connection, and assigns TEST as the SSID of the network setting shown in the LAN device list of FIG. 10(b) and an IP address AA:BB:CC:DD to be used. In this case, the SSID means the identification of an access point in a wireless LAN. The IP address means the identification number of the terminal apparatus assigned when the apparatus is connected to a network such as a wireless LAN.

Next, the schedule manager circuit 103 activates a presentation software when there is the presentation software such as a PPT file as the contents stored in the detected storage device regarding the (3) activation of objective application, and selects activation of the application program for transmitting the display data. The schedule manager circuit 103 selects playback or reproduction of the display data by means of a slide regarding the (4) data formation.

Next, the schedule manager circuit 103 selects the display terminal apparatus defined as Target-T (Name) as the objective display terminal apparatus to which the display data is transmitted as shown in FIG. 10(b) regarding the (5) transmission destination selection. The schedule manager circuit 103 selects the display data transceiving (transmitting and receiving) process regarding the (6) data transceiving process. As described above, the execution processing schedule shown in FIG. 10(c) is formed by the schedule manager circuit 103.

The detected storage device, LAN device and display terminal apparatus are each controlled according to the execution processing schedule shown in FIG. 10(c), and the display data automatic transmission is performed.

That is, referring to FIG. 10(c), the USB memory is first controlled as the (1) storage device. The control of connecting the (2) detected wireless BB device (TEST is assigned as the SSID, and AA:BB:CC:DD is assigned as the IP address) to a predetermined wireless LAN network is performed to complete the advance preparation. The presentation software such as a PPT file as the (3) contents data, and the data transmission application software for transmitting the data are activated to complete data transmission preparation. A slide of the display data is formed regarding the (4) data formation. Next, automatic connection to the (5) objective display terminal apparatus (Target-T) of the transmission destination is performed. After the (6) connection completion, the display data is actually automatically transmitted to the display terminal apparatus (Target-T). Although the objective terminal is stated in the case where the display terminal apparatus (Target-T) is registered in the figure, it is also possible, when there is only one displayable terminal on the connected network, to connect the only one terminal as the objective display terminal and automatically transmit the display data.

As described above, the automatic device control apparatus 100 of the first embodiment is configured to include the device detector circuit 101, the device information acquiring circuit 102, the schedule manager circuit 103, the registration LAN device setting circuit 104, the registration LAN device storage circuit 105, the display terminal retrieving circuit 106, and the display terminal connecting circuit 107.

The device detector circuit 101 detects whether or not the external storage device that stores the display data has been connected to the information processing apparatus such as a personal computer on which the automatic device control apparatus 100 is mounted. The device information acquiring circuit 102 acquires the detailed information of the external storage device detected based on the external storage device detection result inputted from the device detector circuit 101. The registration LAN device setting circuit 104 forms the detailed information of the prioritized LAN device by extracting the LAN device that is effectively communicable with the information processing apparatus. The registration LAN device storage circuit 105 stores the LAN device detailed information inputted from the registration LAN device setting circuit 104 or the LAN device detailed information that has preparatorily been stored. The schedule manager circuit 103 performs an activation judging process as to whether or not the LAN device and the external storage device are activated based on the device detailed information 89-1 inputted from the device information acquiring circuit 102 and the LAN device detailed information 89-2 inputted from the registration LAN device storage circuit 105, and forms a predetermined execution processing schedule 93 by applying the detailed information 90 and the registered data 92 of the activated device to the registration and execution processing schedule 91 when the devices are activated. The display terminal retrieving circuit 106 automatically retrieves the objective display terminal apparatus to which the display data is transmitted according to the execution processing schedule 93. The display terminal connecting circuit 107 completes the process of connection to the display terminal apparatus retrieved by the display terminal retrieving circuit 106, and transmits the display data to the display terminal apparatus.

As described above, according to the automatic device control apparatus 100 of the first embodiment, the execution processing schedule 93 is automatically formed with the event that the external storage device has been connected to the information processing apparatus served as a trigger, automatically retrieves the display terminal apparatus according to the execution processing schedule 93, and transmits the display data to the retrieved display terminal apparatus. Therefore, it is possible for the user to automatically transmit the desired display data to the display terminal apparatus of which the connection has been completed by merely connecting the storage device such as a USB device that stores the display data to the information processing apparatus.

Therefore, the control of, for example, activating the predetermined application, specifying the objective display terminal apparatus of transmission and selecting the transmission data, which is necessary each time of transmitting the display data, becomes unnecessary. Moreover, since it is unnecessary to specify the information of the network to be used, the information of the LAN device (communication device) and so on when various settings are performed, the user needs not to have preliminary knowledges. Therefore, it is possible to improve the convenience.

### Second Embodiment

A second embodiment of the present disclosure is described. A personal computer 10 according to the second embodiment is characterized by including an display data automatic transmission process program 100P for executing the automatic device control process.

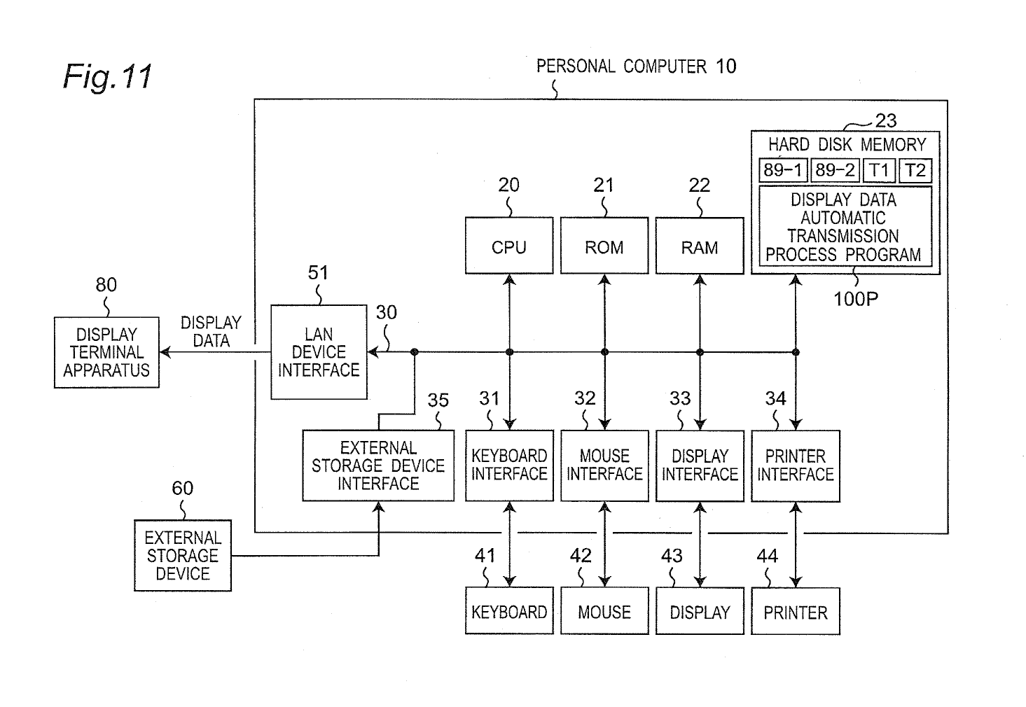

FIG. 11 is a block diagram showing a personal computer (information processing apparatus) 10 having a display data automatic transmission process program 100P of the second embodiment of the present disclosure.

Referring to FIG. 11, the personal computer 10 is configured to include the following:

(a) a CPU (central processing unit) 20 that controls the overall operation and the overall processing of the personal computer 10;

(b) a ROM (read only memory) 21 that stores a base program such as an operation program and data necessary for executing the program;

(c) a RAM (random-access memory) 22 that operates as a working memory of the CPU 20, and temporarily stores data (including, for example, the device driver of the device to be used, the execution processing schedule 93, etc.) necessary upon, for example, executing the display data automatic transmission process program 100P;

(d) a hard disk memory 23 that stores the display data automatic transmission process program 100P, and various data (device detailed information 89-1, LAN device detailed information 89-2, storage device table T1, registered LAN device table T2, etc.);

(e) a LAN device interface 51 that is connected via the communication network of LAN or the like, and transmits and receives display data to the display terminal apparatus 80 such as a projector;

(f) a keyboard interface 31 that is connected to a keyboard 41 for inputting predetermined data and instruction commands, performs an interfacing process such as predetermined signal conversion by receiving the data and instruction commands inputted from the keyboard 41, and performs transmission to the CPU 20;

(g) a mouse interface 32 that is connected to a mouse 42 for inputting instruction commands on a display 43, performs an interfacing process such as predetermined signal conversion by receiving the data and instruction commands inputted from the mouse 42, and performs transmission to the CPU 20;

(h) a display interface 33 that is connected to the display 43 to display data and the like processed by the CPU 20, converts the image data to be displayed into an image signal for the display 43, and outputs the image data to the display 43 to display the data;

(i) a printer interface 34 that is connected to a printer 44 to print data and the like processed by the CPU 20, performs predetermined signal conversion of the print data for printing and so on, and outputs the resulting signal to the printer 44 to perform printing; and

(j) an external storage device interface 35 that is connected to an external storage apparatus 60 of, for example, an USB memory, performs predetermined signal conversion of the read display data and so on, and transfers the resulting signal to the CPU 20 or the hard disk memory 23,

where these circuits 20 to 23, 31 to 35 and 51 are mutually electrically connected via a bus 30.

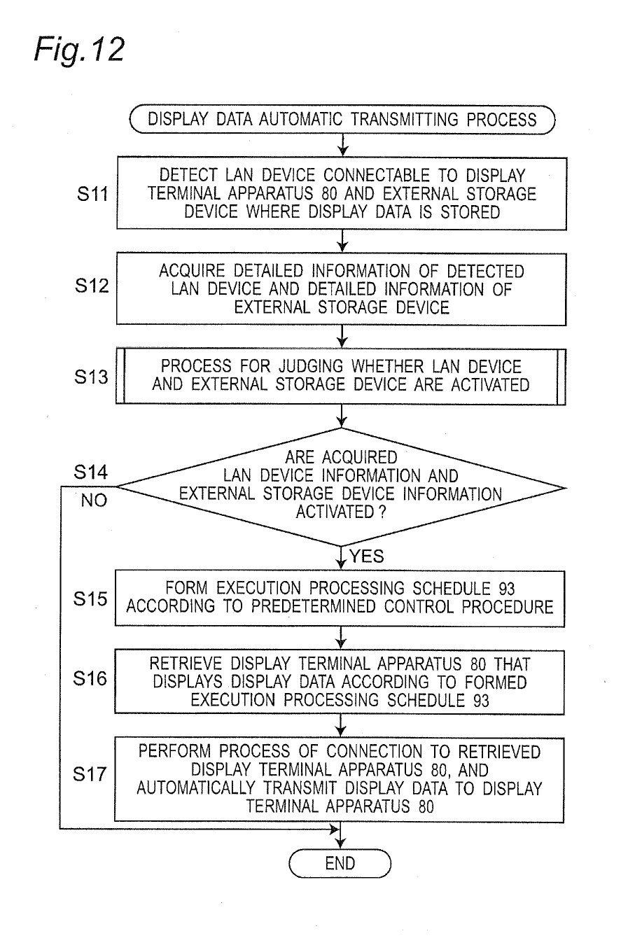

FIG. 12 is a flow chart showing a display data automatic transmission process in the display data automatic transmission process program 100P of FIG. 11. The display data automatic transmission process shown in FIG. 12 is started with the event that the external storage apparatus 60 is connected to the personal computer 10 of the information processing apparatus served as a trigger, and executed by the CPU 20 according to the display data automatic transmission process program 100P.

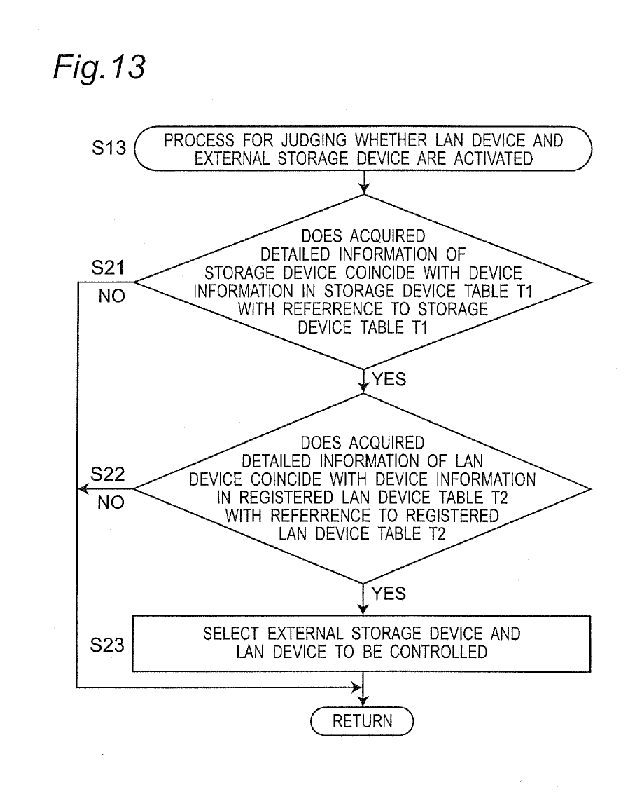

In step S11 of FIG. 12, the CPU 20 detects the LAN device (for example, the display terminal apparatus 80 connected to the LAN device interface 51) connectable to the personal computer 10 of the information processing apparatus and the external storage device (for example, the external storage device 60 connected to the external storage device interface 35) that stores the display data. In step S12, the CPU 20 acquires the detailed information of the detected LAN device and the detailed information of the external storage device. Next, in step S13, the CPU 20 performs an activation judging process of the LAN device and the external storage device. The activation judging process is described in detail later with reference to FIG. 13. In step S14, the program flow proceeds to step S15 when the acquired LAN device information and external storage device information are activated (YES) or ends the process when it is judged that the information are not activated (NO).

Next, in step S15, the CPU 20 forms an execution processing schedule according to a predetermined control procedure. More concretely, when the activation judging process is activated, a predetermined execution processing schedule 93 is formed by applying the detailed information 90 and the registered data 92 of the activated device to the registration and execution processing schedule 91. Next, in step S16, the CPU 20 retrieves the display terminal apparatus 80 to display the display data according to the formed execution processing schedule 93. In step S17, the CPU 20 performs a process of connection to the retrieved display terminal apparatus 80, automatically transmits the display data to the display terminal apparatus 80, and ends the process.

FIG. 13 is a flow chart showing an activation judging process of a LAN device and an external storage device, serving as a subroutine of FIG. 12.

In step S21 of FIG. 13, the CPU 20 judges whether or not the acquired storage device detailed information (for example, 89-1) coincides with the device information in the storage device table T1 with reference to the storage device table T1. In the non-coincidental case (NO) in step S21, the program flow returns to the main routine. Next, in the coincidental case (YES) in step S21, the CPU 20 judges in step S22 whether or not the acquired LAN device detailed information 89-2 coincides with the device information in the registered LAN device table T2 with reference to the registered LAN device table T2. In the non-coincidental case (NO) in step S21, the program flow returns to the main routine. Further, in the coincidental case (YES) in step S22, the CUP 20 selects the objective external storage device (for example, 60) and the objective LAN device (for example, 51 and 80) to be controlled in step S23, and generates the activated device detailed information 90.

As described above, according to the second embodiment, operational effects similar to those of the first embodiment are obtained. Moreover, as in the second embodiment, it is also possible to provide an display data automatic transmission process program 100P for executing the automatic device control process shown in FIG. 12 at need.

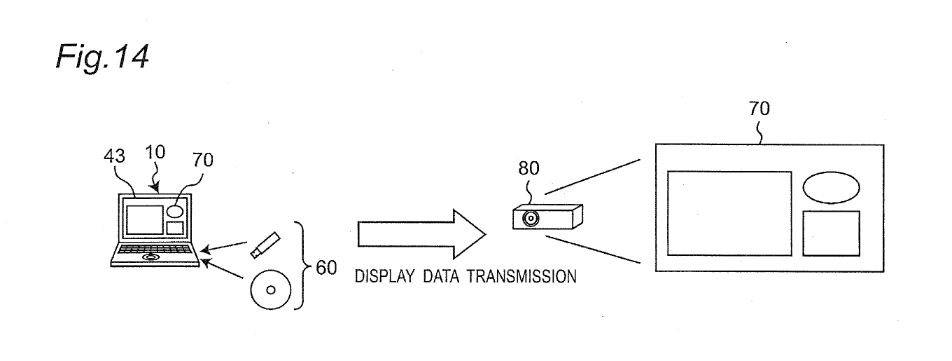

FIG. 14 is a diagram for explaining one example of transmitting the display data when the external storage device 60 is inserted into the personal computer 10 having a display data automatic transmission process program 100P of the second embodiment of the present disclosure.

Referring to FIG. 14, according to the second embodiment, when the external storage device 60 such as an USB memory that stores the desired display data is connected to the personal computer 10 of the information processing apparatus, the event is automatically detected, and the predetermined execution processing schedule 93 necessary for transmitting the display data is formed. The display terminal apparatus 80 is retrieved according to the execution processing schedule 93, and the display data is transmitted to the display terminal apparatus 80. Therefore, it is possible for the user to automatically transmit the desired display data to the display terminal apparatus 80 of which the connection has been completed by merely connecting the storage device 60 that stores the display data to the personal computer 10. As a result, a display 70 identical to the display 70 on the display 43 of the personal computer 10 by the display data is projectedly displayed by the terminal apparatus 80.

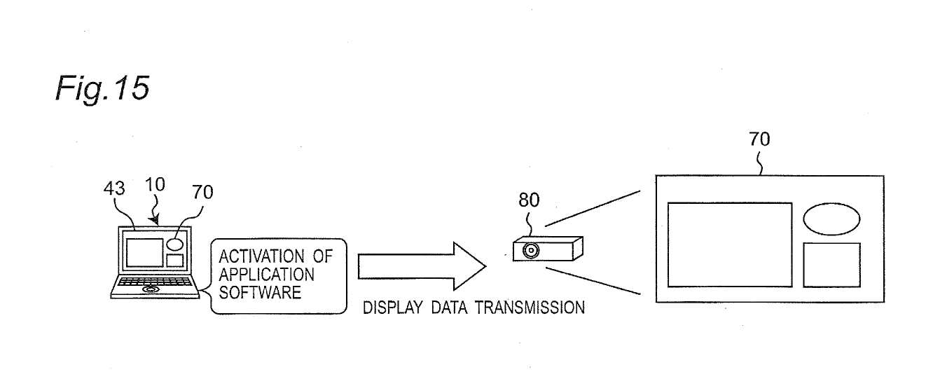

FIG. 15 is a diagram for explaining an example in which the application software (device in a broad sense) that displays or edits (at least displays) the display data is activated in the personal computer 10 having a display data automatic transmission process program 100P of the second embodiment of the present disclosure. Referring to FIG. 15, it is also possible to simply transmit the desired display data to the display terminal apparatus 80 by performing a similar control process by detecting not only the connection of the external storage apparatus 60 but also the activation of a specific application program of the personal computer 10. For example, upon detecting the specific application program (for example, PPT presentation software) of the personal computer 10, the CPU 20 forms a similar execution processing schedule 93. Next, the CPU 20 likewise retrieves the display terminal apparatus 80 according to the schedules (1) to (6) (note that the activation of the application program of the schedule (3) is excluded) in the execution processing schedule 93, and transmits the display data. As a result, when the specific application program of the personal computer 10 is activated, the display 70 identical to the display 70 on the display 43 of the personal computer 10 is projectedly displayed by the display terminal apparatus 80.

Although the wired LAN device and the wireless LAN device are enumerated as one example of the communication device in the first and second embodiments, the disclosure is not limited to this. It is possible to likewise apply the present disclosure even to other communication devices communicable with the information processing apparatus 10.

As described above, the first and second embodiments are described as examples of the technology of the present disclosure. Since the first and second embodiments are for exemplifying the technology of the present disclosure, it is possible to effect various changes, replacements, additions, omissions and the like within the scope of the claims or the scope equivalent to them.

### Other Embodiments

According to the first aspect of the disclosure, there is provided an automatic device control apparatus configured to display display data on a display terminal apparatus connected to an information processing apparatus,

wherein the automatic device control apparatus includes:

a device detecting section configured to detect a corresponding device by detecting one of such an event that an external storage device that stores the display data is connected to the information processing apparatus and such an event that application software to display the display data is activated;

a device information acquiring section configured to acquire information of a detected device based on a detection result of the device detected by the device detecting section;

a communication device setting section configured to extract a communication device communicable with the display terminal apparatus, and generate and setting information of the communication device;

a schedule managing section configured to execute an activation judgment process for judging whether or not the detected device and the communication device are activated based on the information of the detected device and the information of the communication device, and form a predetermined execution processing schedule from the information of the activated detected device and the communication device when it is judged that the detected device and the communication device are activated;

a display terminal retrieving section configured to automatically retrieve the display terminal apparatus to which the display data is transmitted according to the execution processing schedule; and

a display terminal connecting section configured to perform connecting with the retrieved display terminal apparatus, and transmit the display data to the display terminal apparatus.

According to the second aspect of the disclosure, the automatic device control apparatus of the first aspect of the disclosure further includes:

a communication device storage section configured to store one of information of the communication device inputted from the communication device setting section and information of a communication device preparatorily stored.

According to the third aspect of the disclosure, in the automatic device control apparatus of the first or second aspect of the disclosure, the schedule managing section includes a first device table for identifying the activated external storage device and a second device table for identifying the activated communication device, and

wherein the activation judging process includes:

judging whether or not the information of the detected device coincides with device information in the first device table with reference to the first device table;

judging whether or not the information of the communication device coincides with device information in the second device table with reference to the second device table; and

selecting the information of the detected device and the information of the communication device, which are judged to be coincidental, and acquiring the information of the activated detected device and the communication device.

According to the fourth aspect of the disclosure, there is provided an information processing apparatus including the automatic device control apparatus of one of the first to third aspects of the disclosure.

According to the fifth aspect of the disclosure, there is provided an automatic device control method executed by an automatic device control apparatus configured to display display data on a display terminal apparatus connected to an information processing apparatus, and the automatic device control method including:

detecting a corresponding device by detecting one of such an event that an external storage device that stores the display data is connected to the information processing apparatus and such an event that application software to display the display data is activated;

acquiring information of the detected device based on a detection result of the detected device;

extracting a communication device communicable with the display terminal apparatus, and generating and setting information of the communication device;

executing an activation judgment process for judging whether or not the detected device and the communication device are activated based on the information of the detected device and the information of the communication device, and form a predetermined execution processing schedule from the information of the activated detected device and the communication device when it is judged that the detected device and the communication device are activated;

automatically retrieving the display terminal apparatus to which the display data is transmitted according to the execution processing schedule; and

performing connecting with the retrieved display terminal apparatus, and transmitting the display data to the display terminal apparatus.

According to the sixth aspect of the disclosure, the automatic device control method of the fifth aspect of the disclosure further includes:

storing one of information of an inputted communication device and information of a communication device preparatorily stored by the communication device storage section.

According to the seventh aspect of the disclosure, in the automatic device control method of the fifth or sixth aspect of the disclosure, the step of forming the execution processing schedule includes a step of executing the activation judgment process with reference to a first device table for judging an activated external storage device, and a second device table for judging an activated communication device,

wherein the activation judging process includes:

judging whether or not the information of the detected device coincides with device information in the first device table with reference to the first device table;

judging whether or not the information of the communication device coincides with device information in the second device table with reference to the second device table; and

selecting the information of the detected device and the information of the communication device, which are judged to be coincidental, and acquiring the information of the activated detected device and the communication device.

The present disclosure is applicable to an automatic device control apparatus that transmits display data to a display terminal apparatus. In concrete, it is applicable to an automatic device control apparatus that automatically detects the external storage device and the LAN device to be used, automatically controls the LAN device based on contents included in the devices and the execution processing schedule formed based on them, automatically activates the application software for data transmission, and automatically transmits the desired display data to the objective display terminal apparatus. According to the above configuration, it is possible to eliminate the labor of activating the necessary application and manually selecting the objective display terminal apparatus without manually performing communication settings of the network and the like by the user. Therefore, it is useful as the automatic device control apparatus that allows the data transmission of the display data to be more simply performed.

Although the present disclosure has been fully described in connection with the embodiments thereof with reference to the accompanying drawings, it is to be noted that various changes and modifications are apparent to those skilled in the art. Such changes and modifications are to be understood as included within the scope of the present disclosure as defined by the appended claims unless they depart therefrom.

What is claimed is:

1. An automatic device control apparatus configured to display display data on a display terminal apparatus connected to an information processing apparatus, the automatic device control apparatus comprising:
a device detecting section configured to detect a corresponding device by detecting one of such an event that an external storage device that stores the display data is connected to the information processing apparatus and such an event that application software to display the display data is activated;
a device information acquiring section configured to acquire information of a detected device based on a detection result of the device detected by the device detecting section;
a communication device setting section configured to extract a communication device communicable with the display terminal apparatus, and generate and setting information of the communication device;
a schedule managing section configured to execute an activation judgment process for judging whether or not the detected device and the communication device are activated based on the information of the detected device and the information of the communication device, and form a predetermined execution processing schedule from the information of the activated detected device and the communication device when it is judged that the detected device and the communication device are activated;
a display terminal retrieving section configured to automatically retrieve the display terminal apparatus to which the display data is transmitted according to the execution processing schedule; and
a display terminal connecting section configured to perform connecting with the retrieved display terminal apparatus, and transmit the display data to the display terminal apparatus.

2. The automatic device control apparatus as claimed in claim 1, further comprising:
a communication device storage section configured to store one of information of the communication device inputted from the communication device setting section and information of a communication device preparatorily stored.

3. The automatic device control apparatus as claimed in claim 1,
wherein the schedule managing section comprises a first device table for identifying the activated external storage device and a second device table for identifying the activated communication device, and
wherein the activation judging process comprises:
judging whether or not the information of the detected device coincides with device information in the first device table with reference to the first device table;
judging whether or not the information of the communication device coincides with device information in the second device table with reference to the second device table; and
selecting the information of the detected device and the information of the communication device, which are judged to be coincidental, and acquiring the information of the activated detected device and the communication device.

4. An information processing apparatus comprising an automatic device control apparatus configured to display display data on a display terminal apparatus connected to an information processing apparatus,
wherein the automatic device control apparatus comprising:
a device detecting section configured to detect a corresponding device by detecting one of such an event that an external storage device that stores the display data is connected to the information processing apparatus and such an event that application software to display the display data is activated;
a device information acquiring section configured to acquire information of a detected device based on a detection result of the device detected by the device detecting section;
a communication device setting section configured to extract a communication device communicable with the display terminal apparatus, and generate and setting information of the communication device;
a schedule managing section configured to execute an activation judgment process for judging whether or not the detected device and the communication device are activated based on the information of the detected device and the information of the communication device, and form a predetermined execution processing schedule from the information of the activated detected device and the communication device when it is judged that the detected device and the communication device are activated;
a display terminal retrieving section configured to automatically retrieve the display terminal apparatus to which the display data is transmitted according to the execution processing schedule; and
a display terminal connecting section configured to perform connecting with the retrieved display terminal apparatus, and transmit the display data to the display terminal apparatus.

5. An automatic device control method executed by an automatic device control apparatus configured to display display data on a display terminal apparatus connected to an information processing apparatus, the automatic device control method comprising:
detecting a corresponding device by detecting one of such an event that an external storage device that stores the display data is connected to the information processing apparatus and such an event that application software to display the display data is activated;
acquiring information of the detected device based on a detection result of the detected device;
extracting a communication device communicable with the display terminal apparatus, and generating and setting information of the communication device;
executing an activation judgment process for judging whether or not the detected device and the communication device are activated based on the information of the detected device and the information of the communication device, and form a predetermined execution processing schedule from the information of the activated detected device and the communication device when it is judged that the detected device and the communication device are activated;
automatically retrieving the display terminal apparatus to which the display data is transmitted according to the execution processing schedule; and
performing connecting with the retrieved display terminal apparatus, and transmitting the display data to the display terminal apparatus.

6. The automatic device control method as claimed in claim 5, further comprising:
storing one of information of an inputted communication device and information of a communication device preparatorily stored by the communication device storage section.

7. The automatic device control method as claimed in claim 5,
wherein, the step of forming the execution processing schedule includes a step of executing the activation judgment process with reference to a first device table for judging an activated external storage device, and a second device table for judging an activated communication device,
wherein the activation judging process comprises:
judging whether or not the information of the detected device coincides with device information in the first device table with reference to the first device table;
judging whether or not the information of the communication device coincides with device information in the second device table with reference to the second device table; and
selecting the information of the detected device and the information of the communication device, which are judged to be coincidental, and acquiring the information of the activated detected device and the communication device.
